(19) United States
(12) Patent Application Publication
(10) Pub. No.: US 2009/0056189 A1
(43) Pub. Date: Mar. 5, 2009

(54) System and method for displaying information

(76) Inventor: Han Hien Lu, Marietta, GA (US)

Correspondence Address: Han Hien Lu, 1488 Monarch Court, Marietta, GA, 30064, US

(21) Appl. No.: 11/899,301

(22) Filed: Sep. 5, 2007

(51) Int. Cl. G09F 3/18

(52) U.S. Cl. 40/661.02; 362/98

(57) ABSTRACT

System and method for displaying information in low ambient light. A display includes a support backing to provide structural support, an illuminated backing coupled to the rigid backing, an information sheet coupled to the illuminated backing, a power source coupled to the illuminated backing, and a switch to control the power source. The illuminated backing provides a substantially even and diffuse light across a surface of the illuminated backing. The information sheet containing information to be illuminated by the illuminated backing and the power source to provide electrical power to illuminate the light. The light provided by the illuminated backing illuminates the information to enable reading of the information in situations where there is low ambient light.

### TECHNICAL FIELD

The present invention relates generally to a system and method for displaying information, and more particularly to a system and method for displaying information in low ambient light.

### BACKGROUND

Finely printed information may be difficult to read, especially in situations wherein there is little ambient lighting, such as in a dimly-lit restaurant, bar, store, theater, library, or so forth. The low ambient light may make the recognition of text difficult due to a low contrast between the printed text and the paper on which the text is printed. This may be further exacerbated by the use of decorative print fonts and hand-writing.

A relatively simple solution that helps to improve the readability of the printed text in such situations is to increase the overall light level. However, increasing the light level may decrease the ambience and reduce an inherent privacy level provided by the low light. For example, a starkly lit restaurant may not be attractive to people desirous for an intimate meal. Furthermore, in situations such as a theater, it may not be possible to increase the ambient light.

Another solution may involve providing a light that may be used to illuminate the printed text. For example, a display may be provided along with a light, either given directly to a patron or attached to the display. Then, when the patron wishes the read the display, the patron may illuminate the display with the provided light. Then, when the reading is complete, the patron may simply turn off the light, immersing the table in relative darkness.

A disadvantage of the above solution is that the light may tend to be bulky since they may require a separate power source. Furthermore, lights attached to the printed text may be prone to damage as they are being handled. Additionally, lights not attached to the printed text may be prone to being misplaced since they are separate from the printed text. Having to continually replace the lights may be an undesired expense.

Yet another solution may involve the use of a computer display, such as a cathode ray tube display or a liquid crystal display, which may be used to display the information. The displays may be self-illuminated, therefore, they provide an adjustable amount of light that may be configured to meet the reading needs without raising the overall light level.

A disadvantage of the above solution is that the computer display may be expensive, especially if a large number of the displays are needed. Also, providing power to the computer displays may be difficult and the power supplies may be bulky and may add undesired weight to the printed text. Additionally, the presence of computer displays may not be conducive in helping to create a desired environment. For example, a large number of computer displays may destroy a romantic environment of a restaurant.

### SUMMARY OF THE INVENTION

These and other problems are generally solved or circumvented, and technical advantages are generally achieved, by embodiments of a system and a method for displaying information in low ambient light.

In accordance with an embodiment, a display is provided. The display includes a support backing to provide structural support, an illuminated backing coupled to the rigid backing, an information sheet coupled to the illuminated backing, a power source coupled to the illuminated backing, and a switch to control the power source. The illuminated backing provides a substantially even and diffuse light across a surface of the illuminated backing, the information sheet contains information to be illuminated by the illuminated backing, and the power source provides electrical power to illuminate the light.

In accordance with another embodiment, a display is provided. The display includes a support backing to provide structural support, the support backing having a fold formed an axis of the support backing, an illuminated backing to provide a substantially even and diffuse light across a surface of the illuminated backing, and a binder disposed in the fold. The light provided by the illuminated backing illuminates information to enable reading of the information, and the binder couples the illuminated backing to the support backing.

In accordance with another embodiment, a method for displaying information on a self-illuminated display is provided. The method includes providing the information to the self-illuminated display, and switching on the self-illuminated display in response to a determining that a reader is attempting to read the information, wherein the switching on illuminates the information.

An advantage of an embodiment is that information may be provided in an easy to read form without requiring a large monetary investment. Thereby helping to expedite the acceptance of the embodiment.

A further advantage of an embodiment is that the information may be readily changed. Once an initial investment is made, the information may be easily changed without requiring any additional monetary investments. For example, the information may be altered without incurring reprinting costs, assembly costs, and so forth.

Yet another advantage of an embodiment is that the widely accepted form factor may be maintained. For example, a restaurant's menu design may be maintained, therefore, the embodiment does not alter the purposely create environment of the restaurant with large computer displays, menus illuminated with hand-held lights, and so on.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a self-illuminated display;

FIG. 2 is a diagram of a self-illuminated display with a motion sensor;

FIG. 3 is a diagram of a self-illuminated display with a contact switch;

FIG. 4a is a diagram of a folded self-illuminated display;

FIG. 4b is a diagram of a charging tray for the self-illuminated display;

FIG. 5 is a diagram of an electroluminescent sheet;

FIG. 6 is a diagram of an alternate embodiment of an electroluminescent sheet;

FIGS. 7a and 7b are diagrams of front and side views of a self-illuminated display;

FIGS. 8a and 8b are diagrams of front and side views of a self-illuminated display;

FIGS. 9a and 9b are diagrams of front and side views of a self-illuminated display;

FIGS. 10a and 10b are diagrams of front and side views of a self-illuminated display;

FIGS. 11a and 11b are diagrams of front and side views of a self-illuminated display;

FIGS. 12a and 12b are diagrams of front and side views of a self-illuminated display; and

FIGS. 13a through 13e are diagrams of sequences of events in the displaying of information.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a display for use in a restaurant. The invention may also be applied, however, to other applications wherein there is a desire to provide information, both textual and graphical, in an environment that is not conducive to reading. Examples of such applications may include advertisements in a bar, shopping lists in a store, event information in a theater, reading material in a library, and so forth.

With reference now to FIG. 1, there is shown a self-illuminated display 1. The self-illuminated display 1 includes an electroluminescent sheet 12. The electroluminescent sheet 12 may be printed with the textual and/or graphical information to be displayed. Alternatively, the electroluminescent sheet 12 may be shaped so that it may be used to contain or hold paper printed with the information. For example, the electroluminescent sheet 12 may be shaped like a pocket so that a paper containing information may be inserted into the pocket. The paper may also be attached to the electroluminescent sheet 12 using an adhesive, preferably a non-permanent adhesive that may enable the removal of the paper without destroying either the paper or the electroluminescent sheet 12. The electroluminescent sheet 12 may be thin, much like a sheet of paper itself. Furthermore, the electroluminescent sheet 12 may be bendable or foldable so that it does not become damaged when bended or folded. The electroluminescent sheet 12 may be formed from an electroluminescent material, which, when power is applied may glow with sufficient light to permit easy reading of print contained on a page of paper contained therein.

Although described herein as a display, the embodiment may be any other form of printed information, such as a menu, an advertisement, reading material, shopping lists, and so forth. Therefore, the discussion of a display should not be construed as being limiting to either the scope or the spirit of the embodiments.

The self-illuminated display 1 also includes a support backing 10. The support backing 10 may be used to provide a measure of rigidity to the self-illuminated display 1, to help make the self-illuminated display 1 easier to hold and manipulate, and so forth. The support back 10 may comprise a single flat surface to which the electroluminescent sheet 12 may be attached.

Alternatively, the support back 10 may be a folder, for example, a bi-fold or tri-fold folder, and the electroluminescent sheet (or sheets) 12 may be contained therein. For example, if the support back 10 is in the form of a bi-fold folder, the self-illuminated display 1 may contain one or more electroluminescent sheets 12. If the self-illuminated display 1 contains one electroluminescent sheet 12, then the electroluminescent sheet 12 may be attached to one fold of the bi-fold folder. If the self-illuminated display 1 contains two electroluminescent sheets 12, then each electroluminescent sheet 12 may be attached to a side of the support backing 10. If the self-illuminated display 1 contains more than two electroluminescent sheets 12, then the electroluminescent sheets 12 may be attached to a binder placed along a fold of the bi-fold folder.

The electroluminescent sheet 12 may be powered by a circuit and power source block 13. The circuit and power source block 13 may contain necessary circuitry to provide power to the electroluminescent sheet 12 and may contain circuit elements such as a voltage regulators, resistors, and so forth. The circuit and power source block 13 may also include a power source, such as a battery to provide power to the electroluminescent sheet 12.

The self-illuminated display 1 may further include a switch 14, such as a contact switch, that may detect when the self-illuminated display 1 may have been opened, to be read, for example. When the switch 14 detects that the self-illuminated display 1 has been opened, the circuit and power source block 13 may power the electroluminescent sheet 2 and illuminate the information. When the switch 14 detects that the self-illuminated display 1 may have been closed, then the circuit and power source block 13 may power down the electroluminescent sheet 12 to conserve power.

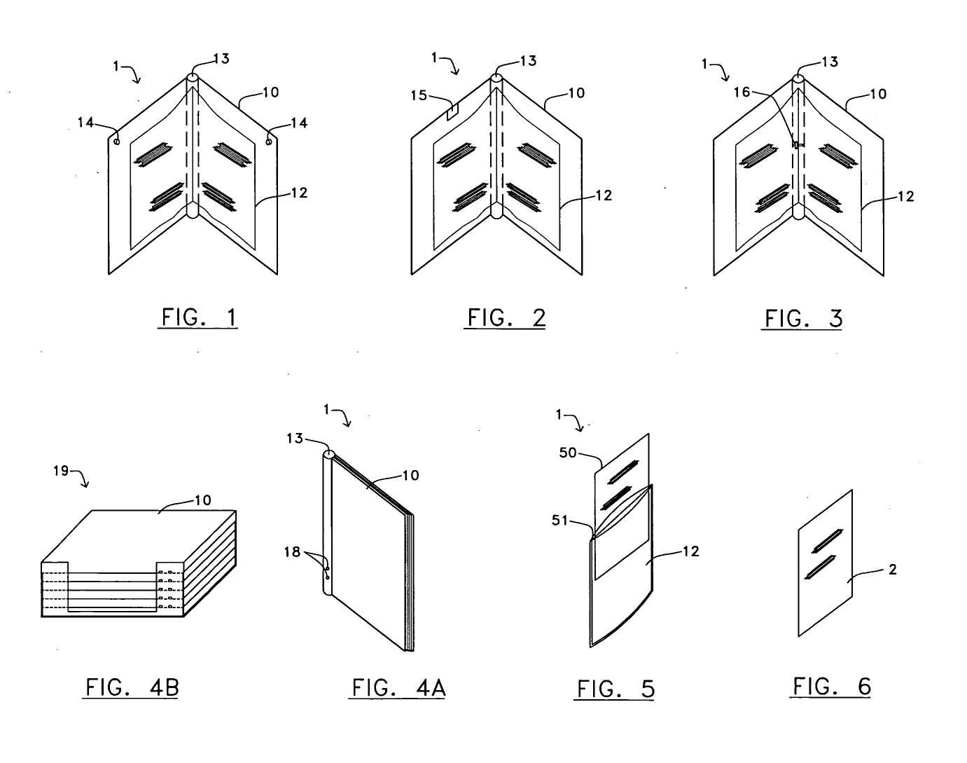

FIG. 2 illustrates the self-illuminated display 1 with a motion sensor 15 in place or the switch 14. The motion sensor 15 may detect the motion of the opening of the self-illuminated display 1 and cause the circuit and power block 13 to power the electroluminescent sheet 12 and illuminate the information. Similarly, FIG. 3 illustrates the self-illuminated display 1 with a contact switch 16 to detect the opening and the closing of the self-illuminated display 1.

FIG. 4a illustrates the self-illuminated display 1 in a folded or closed state. The circuit and power block 13 may have pins (or knobs) 18 that may permit a charging of the power source contained in the circuit and power block 3. FIG. 4b illustrates a charging tray 19 that may be used to hold the self-illuminated display 1 in position so that the power source in the circuit and power block 13 may be recharged. The charging tray 19 may be able to hold a number of the self-illuminated displays and provide the necessary power to recharge the power source contained in each. Alternatively, the self-illuminated display 1 may be formed so that when stacked over other self-illuminated displays, an electrical connection may be created, permitting the stack of self-illuminated displays may all be charged.

FIG. 5 illustrates an embodiment of the electroluminescent sheet 12. The electroluminescent sheet 12 may be formed as an envelop 51 that may be used to hold a page of paper 50 printed with the information. The envelop 51 may have a backside and a frontside, with the backside preferably being formed from the electroluminescent sheet 12 while the frontside being from an optically transparent material. The page of paper 50 may be inserted inside the envelop 51. For example, each time the information needs to be altered, a new page of paper may be printed and then inserted into the envelop 51. FIG. 6 illustrates an embodiment of the electroluminescent sheet 12 wherein the information may be directly printed onto the electroluminescent sheet 12. The surface of the electroluminescent sheet 12 may be treated with a material or a chemical that may allow for easy removal of the printed information. Alternatively, the printed information may be printed onto the electroluminescent sheet 12 using a process or material that may be readily removed.

Alternatively, the electroluminescent sheet 12 may be used to mount a page of paper printed with the information. The electroluminescent sheet 12 may include a surface with a mild adhesive, glue, a mechanical fastener, or so forth, which may permit the attachment and detachment of the page of paper. The page of paper may then be removed and replaced with a new page of paper when the information is to be changed.

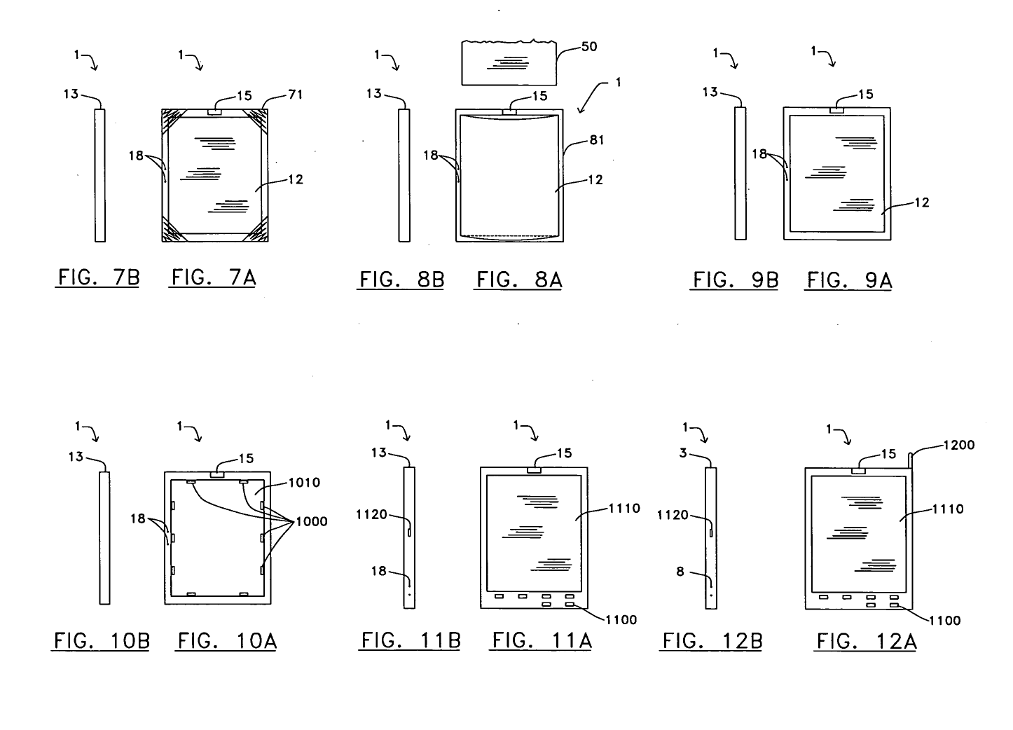

FIGS. 7a and 7b illustrate front and side views of an embodiment of the self-illuminated display 1. FIG. 7a illustrates a front view of the self-illuminated display 1, wherein the self-illuminated display 1 is designed as a single pane. The electroluminescent sheet 12 containing information may be attached to a support backing by a binding cover 71 and the slide switch 15 may be used to turn the self-illuminated display 1 on or off. Pins 18 may permit a charging of a battery contained in the circuit and power block 13, shown in FIG. 7b.

FIGS. 8a and 8b illustrate front and side views of an embodiment of the self-illuminated display 1. A page 50 containing printed information may be inserted into a binder 81, which may contain the electroluminescent sheet 12 formed as a pocket to accept the page 50. The slide switch 15 may be used to turn the self-illuminated display 1 on or off. Pins 18 may permit a charging of a battery contained in the circuit and power block 13, shown in FIG. 8b. Although shown on the side of the self-illuminated display 1, the circuit and power block 13 may be arranged so that it runs about a portion or an entirety of a perimeter of the self-illuminated display 1. FIGS. 9a and 9b illustrate front and side views of the illuminated display 1 wherein printed information may be printed directly on the electroluminescent sheet 12.

FIG. 10a illustrates a front view of an alternate embodiment of a self-illuminated display 1, wherein the illumination of the printed information contained on the display may be provided by light sources 1000, such as light emitting diodes (LED) and other forms of solid-state lighting. Other sources of illumination may be compact halogen lights, incandescent lights, compact fluorescent lights, cold cathode lights, and so on. The number of light sources 1000 may be arranged about a perimeter of the self-illuminated display 1, with a specific number and placement of the light sources 1000 being dependent on factors such as a light output or the individual light sources 1000, a total number of light sources 1000, desired amount of illumination, available power, battery life, and so forth. A protective plate 1010 may be used to provide a measure of protection for the printed information. FIG. 10b illustrates a side view of the self-illuminated display 1, showing the circuit and power block 13.

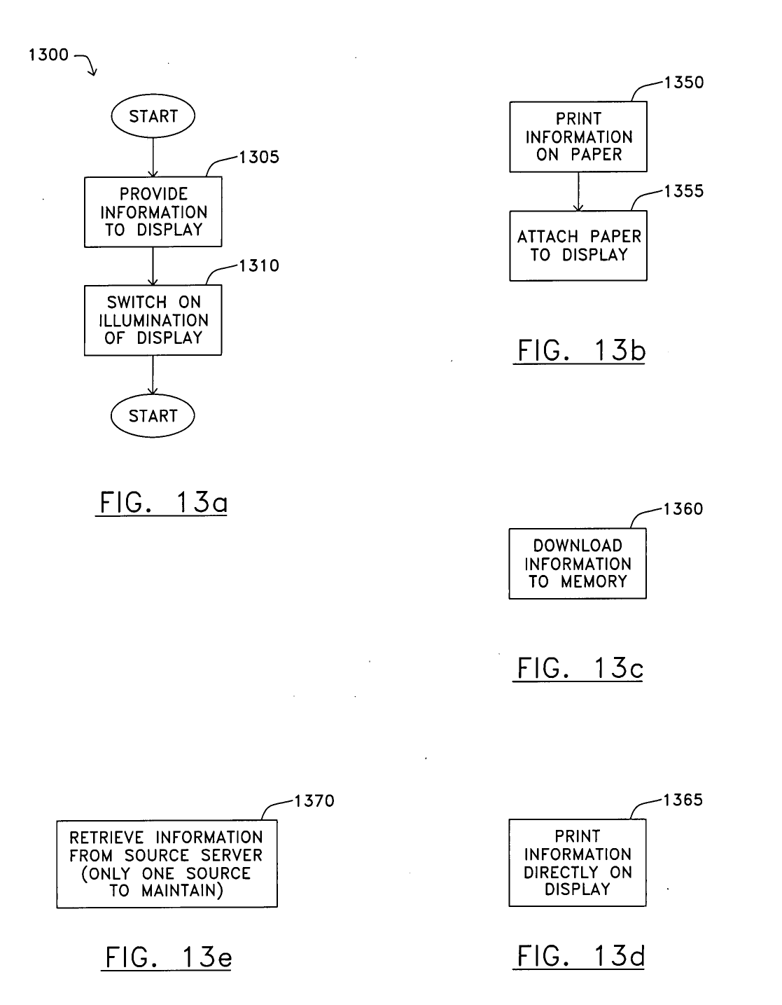

FIG. 11a illustrates a front view of yet another alternate embodiment of a self-illuminated display 1, wherein a data display panel 1110 may be used to display the printed information. The data display panel 1110 may be created using electronic paper displays, thin-film transistors printed on polymer and metal-foil substrates, thin liquid crystal displays, displays containing organic light emitting diodes, and so forth. The data display panel 1110 may be of the back lit variety to increase readability in low light situations. Buttons 1100 may be used to provide navigation, such as scrolling, panning, and so forth, through the printed information displayed on the data display panel 1110. Furthermore, at least some of the buttons 1100 may be programmable by a vendor of the self-illuminated display 1 to enable customization of the self-illuminated display 1 per client needs.

FIG. 11b illustrates a side view of the self-illuminated display 1, shown charging pins 8 for use in charging a power source located in the self-illuminated display 1. The self-illuminated display 1 may also include a data port 1120 to permit the coupling of the self-illuminated display 1 to a computer, a personal digital assistant, or some other form of electronic device to allow for the downloading of the printed information into the self-illuminated display 1. Additionally, the data port 1120 may permit the insertion of a memory card, a thumb drive, or so on, wherein the inserted device may contain the printed information to be downloaded into the self-illuminated display 1. In addition to the transfer of the printed information into the self-illuminated display 1, the data port 1120 may be used for upgrading of software as well as for debugging purposes.

In yet another alternative of the self-illuminated display 1, the self-illuminated display 1 may have the capability to communicate wirelessly to receive the printed information, for example. FIGS. 12a and 12b illustrate front and side views of the self-illuminated display 1, wherein the self-illuminated display 1 includes an antenna 1200 for wireless communications purposes. Although shown to be an external antenna, the antenna 1200 may also be integrated inside or on the body of the self-illuminated display 1.

FIG. 13a illustrates a sequence of events 1300 in the displaying of information on the self-illuminated display 1. The displaying of information may begin with providing the information to be displayed (block 1305). FIGS. 13b through 13e illustrate several methods for providing information, including printing the information on paper (block 1350, FIG. 13b) and attaching the paper to self-illuminated display 1 (block 1355, FIG. 13b), downloading an electronic version of the information to a memory in the self-illuminated display 1 (block 1360, FIG. 13c), printing information directly onto the self-illuminated display 1 (block 1365, FIG. 13d), and retrieving information from a server to a memory in the self-illuminated display 1 (block 1370, FIG. 13e). After providing the information to be displayed, the self-illuminated display 1 may be switched on (block 1310). The switching on of the self-illuminated display 1 may be manually performed or it may be automatically performed through the use of sliding switches, motion detectors, contact switches, and so forth.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A display comprising:
a support backing to provide structural support;
an illuminated backing coupled to the rigid backing, the illuminated backing configured to provide a substantially even and diffuse light across a surface of the illuminated backing;
an information sheet coupled to the illuminated backing, the information sheet containing information to be illuminated by the illuminated backing;
a power source coupled to the illuminated backing, the power source to provide electrical power to illuminate the light; and
a switch to control the power source.

2. The display of claim 1, wherein the information sheet is the illuminated backing and the information is printed directly on the illuminated backing.

3. The display of claim 1, wherein the information sheet comprises a page of an optically transparent or translucent material and the information is printed on the information sheet.

4. The display of claim 3, wherein the information sheet is inserted inside a pocket formed with the illuminated backing.

5. The display of claim 4, wherein the illuminated backing forms a backside of the pocket and a substantially optically transparent material forms a frontside of the pocket.

6. The display of claim 1, further comprising a pair of charging pins coupled to the power source, the pair of charging pins to permit a recharging of the power source.

7. The display of claim 1, wherein the illuminated backing comprises an electroluminescent sheet.

8. The display of claim 1, wherein the illuminated backing comprising:
an attachment surface for attaching the information; and
an illumination source arranged around a perimeter of the attachment surface.

9. The display of claim 8, wherein the illumination source is selected from the group consisting of: light emitting diodes, fluorescent lights, incandescent lights, halogen lights, and combinations thereof.

10. The display of claim 1, further comprising:
an electronic display coupled to the illuminated backing, the electronic display to display information; and
a data port coupled to the electronic display, the data port to enable a loading of the information into a memory.

11. The display of claim 10, wherein the data port comprises an antenna.

12. The display of claim 10, further comprising at least one button to scroll through the information displayed on the electronic display.

13. A display comprising:
a support backing to provide structural support, the support backing having a fold formed an axis of the support backing;
an illuminated backing to provide a substantially even and diffuse light across a surface of the illuminated backing,
wherein the light provided by the illuminated backing illuminates information to enable reading of the information; and
a binder disposed in the fold, the binder to couple the illuminated backing to the support backing.

14. The display of claim 13, wherein the support backing having a second fold formed along the axis of the support backing.

15. The display of claim 13, further comprising a second illuminated backing coupled to a portion of the support backing on one side of the fold.

16. The display of claim 13, wherein the illuminated backing comprises a plurality of illuminated surfaces with each illuminated surface coupled to the binder.

17. A method for displaying information on a self-illuminated display, the method comprising:
providing the information to the self-illuminated display; and
switching on the self-illuminated display in response to a determining that a reader is attempting to read the information, wherein the switching on illuminates the information.

18. The method of claim 17, wherein the providing comprises:
printing the information on paper; and
attaching the paper to the self-illuminated display.

19. The method of claim 17, wherein the providing comprises printing the information directly on the self-illuminated display.

20. The method of claim 17, wherein the providing comprises downloading an electronic version of the information to a memory in the self-illuminated display.
